(19) United States
(12) Patent Application Publication
(10) Pub. No.: US 2018/0212241 A1
(43) Pub. Date: Jul. 26, 2018

(54) SODIUM SECONDARY BATTERY

(71) Applicant: Chung Yuan Christian University, Taoyuan City (TW)

(72) Inventors: Wei-Jen LIU, Taoyuan City (TW); Irish Valerie B. MAGGAY, Taoyuan City (TW); Tetsu YONEZAWA, Taoyuan City (TW); Mai Thanh NGUYEN, Taoyuan City (TW); Lyn Marie Z. DE JUAN, Taoyuan City (TW)

(73) Assignee: Chung Yuan Christian University, Taoyuan City (TW)

(21) Appl. No.: 15/412,064

(22) Filed: Jan. 23, 2017

(51) Int. Cl. H01M 4/485; H01M 10/054; H01M 4/131; H01M 4/505; H01M 4/525; C01G 51/00; C01G 49/00; C01G 31/00

(52) U.S. Cl. CPC H01M 4/485; H01M 10/054; H01M 4/131; H01M 4/505; C01P 2006/40; C01G 51/42; C01G 49/0027; C01G 31/006; H01M 4/525

(57) ABSTRACT

Disclosed herein is an anode material for constructing an anode of a rechargeable battery, particularly a sodium battery. The anode material comprises, a metal oxide composite having a spinel structure and a formula of AB₂O₄, wherein, A is selected from the group consisting of: zinc, cobalt, iron, nickel, magnesium, manganese, copper and cadmium; and B is selected from the group consisting of: vanadium, cobalt, iron, boron, aluminum, gallium, chromium, and manganese. Also provided herein is a sodium secondary battery including an anode formed from the anode material of the present disclosure that renders the sodium secondary battery a reduced an enhanced level of capacitance, and a long cycle life-time.

### BACKGROUND OF THE INVENTION

### 1. Field of the Invention

The present disclosure relates to a novel anode material for use in a rechargeable sodium battery. Accordingly, the present disclosure also relates to a sodium battery comprising an anode formed from the afore-mentioned novel anode material.

### 2. Description of Related Art

Lithium-ion secondary battery has been widely used in computer, communication and consumer electronics, as well as in electronic tools and vehicles, due to its capability of storing large amount of energy therein (i.e., high energy density). However, the cost for the manufacture of lithium battery remains relatively high, for only limited lithium deposits are available on earth, and most reside in South American. By contrast, sources of sodium are abundant, for example, sodium ions may be easily obtained from the ocean; further, they are environmental friendly and relatively safe to use, as compared to those of lithium. The cost of 1 ton lithium carbonate is about US$5,000, whereas the price of 1 ton sodium carbonate is merely US$150. Thus, one major advantage of sodium battery is its low development cost, as compared to that of a lithium battery.

Materials suitable for use as negative electrode of a sodium battery include, but are not limited to, graphite, soft or hard carbon, metal, alloy, metal oxide (e.g., NaₓVO₂), titanate (e.g., Na₂Ti₃O₇, NaTi₂(PO₄)₃), non-metallic compounds and etc. Since lithium ion is about 0.7 Angstrom (A) in diameter, whereas sodium ion has a radius up to 1.06 Å, accordingly, during the charge and discharge cycle, the high mass transfer resistance of a sodium ion would result in the dis-rupture of its ionic structure, which in turn shortens the battery life. Further, the reduction potential of a lithium ion is about −3.045 V, while that of a sodium ion is about −2.714 V, thus, the amount of energy that can be stored in a sodium battery is relatively less than that of a lithium battery.

In view of the above, there exists in the art a need for an improved anode material that can be used to construct an anode of a sodium battery.

### BRIEF SUMMARY OF THE INVENTION

In view of the afore-identified problems, main objective of the present disclosure is to provide an anode material usable in rechargeable electrochemical cell, particularly in a sodium battery. The rechargeable battery incorporating an anode formed from the anode material of the present disclosure exhibits improved electrochemical properties, such as an enhanced capacitance and a long cycle lifetime.

Generally, in one aspect, the present disclosure provides an anode material, which includes a metal oxide composite having a spinel structure and a formula of AB₂O₄, in which A is selected from the group consisting of: zinc, cobalt, iron, nickel, magnesium, manganese, copper and cadmium; and B is selected from the group consisting of: vanadium, cobalt, iron, boron, aluminum, gallium, chromium, and manganese.

According to some embodiments of the present disclosure, the anode material comprises the metal oxide composite of the formula of AB₂O₄, in which A is zinc and B is vanadium.

According to other embodiments of the present disclosure, the anode material comprises the metal oxide composite of the formula of AB₂O₄, in which A is copper and B is vanadium.

According to further embodiments of the present disclosure, the anode material comprises the metal oxide composite of the formula of AB₂O₄, in which A is iron and B is vanadium.

According to various embodiments of the present disclosure, the metal oxide composite may be produced by a process selected from the group consisting of: hydrothermal, sol-gel, solid state reaction, high energy ball milling, co-sedimentation and a combination thereof.

According to some embodiments of the present disclosure, the metal oxide composite is produced by hydrothermal process, in which the hydrothermal reaction is conducted at a reaction temperature between 25-300° C. for about 1 hour to 7 days; preferably, at the reaction temperature of 200° C. for about 3 days.

According to some embodiments of the present disclosure, the process further comprises sintering the metal oxide composite at a temperature between 200-1,200° C. for about 10 minutes to 72 hours; preferably, at the temperature between 400-600° C. for about 8 hours.

According to one preferred embodiment, a sintered zinc vanadate is produced by the present method (i.e., hydrothermal reaction), and is used to construct an anode of a sodium battery.

Accordingly, a further aspect of the present disclosure is to provide a sodium secondary battery that includes, an anode formed from the anode material of the present invention, a cathode, and an electrolyte. The sodium secondary battery is characterized in having high specific capacity and long cycle lifetime.

The details of one or more embodiments of the invention are set forth in the accompanying description below. Other features and advantages of the invention will be apparent from the detail descriptions, and from claims.

### BRIEF DESCRIPTION OF THE DRAWINGS

The present description will be better understood from the following detailed description read in light of the accompanying drawings, where:

FIG. 1A illustrates the X-ray crystallography of the zinc vanadate composite of example 1.1.1.1;

FIG. 1B is the scanning electromagnetic microscopy (SEM) photograph of the zinc vanadate composite of example 1.1.1.1;

FIG. 2A illustrates the X-ray crystallography of the cobalt vanadate composite of example 1.1.2.1;

FIG. 2B is the scanning electromagnetic microscopy (SEM) photograph of the cobalt vanadate composite of example 1.1.2.1;

FIG. 3A illustrates the X-ray crystallography of the iron vanadate composite of example 1.1.3.1;

FIG. 3B is the scanning electromagnetic microscopy (SEM) photograph of the iron vanadate composite of example 1.1.3.1;

FIG. 4A is a line graph depicting the capacity per gram (milliamp hours per gram, mAh/g) and the efficiency of the sodium cell constructed by use of the coated anode material of examples 1.1.1,

FIG. 4B illustrates the number of charge and discharge cycles and the battery capacity of the sodium cell of FIG. 4A;

FIG. 5 is a line graph depicting the capacity per gram (mAh/g) and the efficiency of the sodium cell constructed by use of the coated anode material of examples 1.1.2; and

FIG. 6 is a line graph depicting the capacity per gram (mAh/g) and the efficiency of the sodium cell constructed by use of the coated anode material of examples 1.1.3.

### DETAILED DESCRIPTION OF THE INVENTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques.

The singular forms “a”, “and”, and “the” are used herein to include plural referents unless the context clearly dictates otherwise.

In the present disclosure, a novel anode material is developed for use in a rechargeable sodium battery. The rechargeable sodium battery comprising the novel anode material of the present disclosure exhibits improved electrochemical properties, including high specific capacity, and a long cycle lifetime.

The present disclosure is based, at least in part, on the development of an anode material suitable for use as an active material for the construction of an anode of a sodium battery. Specifically, the anode material comprises a metal oxide composite having a spinel structure and a formula of AB₂O₄, wherein, A is selected from the group consisting of: zinc, cobalt, iron, nickel, magnesium, manganese, copper and cadmium; and B is selected from the group consisting of: vanadium, cobalt, iron, boron, aluminum, gallium, chromium, and manganese.

In general, the metal oxide composite of the formula of AB₂O₄ may be produced by any process well known to the skilled artisan in the relevant field. Examples of suitable process for producing the metal oxide of the present disclosure include, but are not limited to, hydrothermal, sol-gel, solid state reaction, high energy ball miffing, co-sedimentation and the like. As set forth in the working examples, hydrothermal reaction is adopted to produce the metal oxide composite of the present disclosure, in which the hydrothermal reaction is conducted at a temperature between 25-300° C. for about 1 hour to 7 days, such as at the temperature of 25, 50, 100, 110, 120, 130, 140, 150, 160, 170, 180, 190, 200, 210, 220, 230, 240, 250, 260, 270, 280, 290, or 300° C. for about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 69, 70, 71, 72, 73, 74, 75, 76, 77, 78, 79, 80, 81, 82, 83, 84, 85, 86, 87, 88, 89, 90, 91, 92, 93, 94, 95 or 96 hours. Preferably, the hydrothermal reaction is conducted at the temperature of 200° C. for about 36 hours (or 3 days). In one embodiment, zinc vanadate is produced via hydrothermal process, in which the hydrothermal reaction is conducted at 200° C. for 24 hours. In another embodiment, cobalt vanadate is produced via hydrothermal process, in which the hydrothermal reaction is conducted at 200° C. for 48 hours. In still another embodiment, ferrous vanadate is produced via hydrothermal process, in which the hydrothermal reaction is conducted at 200° C. for 48 hours.

The thus produced metal oxide composite may be further subject to a heat treatment (i.e., sintered) at a temperature between 200 to 1,200° C. for about 10 minutes to 72 hours, such as at the temperature of 200, 300, 400, 500, 600, 700, 800, 900, 1,000, 1,100, or 1,200° C. for about 0.1, 0.2, 0.3, 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 69, 70, 71, or 72 hours. In one embodiment, the zinc vanadate is sintered at 500° C. for 8 hours, and the resulted particle is about 100-200 nm in diameter. In another embodiment, the cobalt vanadate is sintered at 500° C. for 8 hours, and the resulted particle is about 50 nm in diameter. In still another embodiment, the ferrous vanadate is sintered at 500° C. for 8 hours, and the resulted particle is about 20 nm in diameter.

To prepare an anode material, the sintered metal oxide composite (e.g., zinc vanadate) is mixed with a bonding agent, a conductive additive, and a solvent to produce a slurry composition. The slurry composition is then spread over the surface of a copper or an aluminum foil, pressed and cut into suitable size (such as 1 cm×1 cm) for use as an anode. The bonding agent may be any of polyvinylidene fluoride (PVDF), carboxymethyl cellulose (CMC), styrene butadiene rubber (SBR), and etc. The conductive additive may be carbon black (e.g., Super P carbon black), natural or synthetic graphite (e.g., KS6), soft carbon, hard carbon and etc.

A typical cathode (e.g., a sodium disc) suitable for use in the present invention is made up of an aluminum foil covered by a film containing cathode material, binder and conductive additive. Typical binders are polymers such as PVDF and typical conductive additives are carbon fibers or flakes.

The thus produced anode is then assembled with the cathode into a battery (i.e., a sodium ion battery), which can be a coin cell battery or a cylindrical battery, in argon filled environment, in according to procedures described in the examples of the present disclosure.

In one preferred embodiment, a zinc vanadate based sodium battery is provided. The zinc vanadate based sodium battery has an anode formed from the anode material of the present disclosure, in which the anode comprises in its structure, a copper or an alumina foil encapsulated by a slurry composition comprising zinc vanadate that is produced by the procedures described in the working example of the present disclosure. The zinc vanadate based sodium secondary battery has a charge capacity in the range of 550-640 mAh/g and a discharge capacity in the range of 520-540 mAh/g at 0.1 C rate for the first and second cycles, in which the columbic efficiency is 81% for the first cycle, and 98% for the second cycle.

The present invention will now be described more specifically with reference to the following embodiments, which are provided for the purpose of demonstration rather than limitation.

### EXAMPLES

### Example 1 Production of Sodium Battery

1.1 Production of Anode Material

1.1.1 Anode Material Comprising Zinc Vanadate Composite

1.1.1.1 Zinc Vanadate Composite

Ammonium metavanadate (NH₄VO₃, 6 mmol) and zinc nitrate hexahydrate (Zn(NO₃)₂.6H₂O, 3 mmol) were mixed in methanol (40 mL) with continued agitation at a speed of 400 rpm for about 30 min, then added dicarboxylic acid dihydrate (9 mmol). Hydrogen peroxide (2.5 mL) and nitric acid (2.5 mL) were subsequently added into the mixture in a dropwise manner.

The resultant mixture was then transferred to a Teflon-lined autoclaved vessel (100 mL in volume) that was maintained at 200° C. for 24 hrs, before cooling down to ambient temperature. Black precipitates were collected and washed with ethanol, then were subjected to vacuum dried in an oven at 80° C. for overnight. The dried powders were then sintered at 600° C. for 4 hrs at a reducing atmosphere of 15% H₂/85% N₂, and stored in a desiccated place until use.

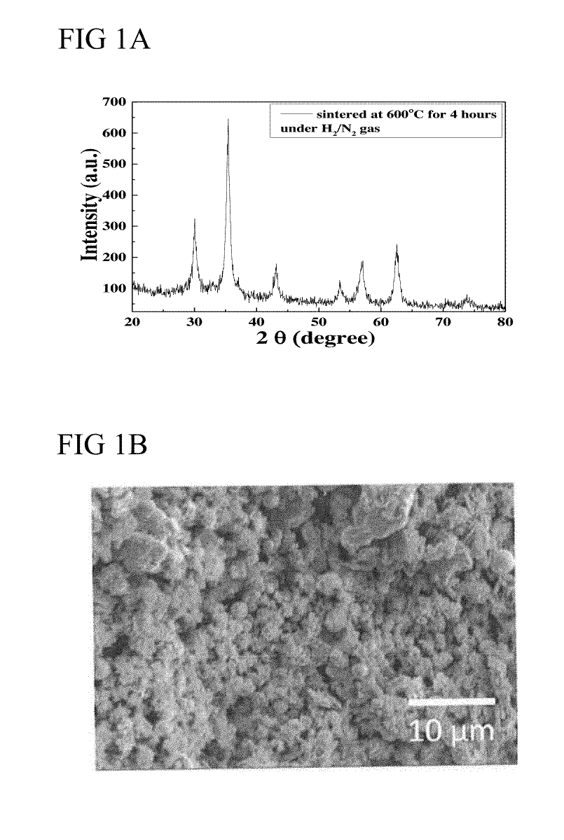

FIGS. 1A and 1B respectively illustrate the X-ray crystallography and scanning electromagnetic microscopy photograph of the thus produced zinc vanadate composite. The zinc vanadate composite of the present example is about 100-200 nm in diameter.

1.1.1.2 Slurry Composition Comprising the Zinc Vanadate Composite of Example 1.1.1.1

In general, the slurry composition comprising the zinc vanadate composite of example 1.1.1.1 was prepared by mixing the zinc vanadate composite of example 1.1.1.1 with KS6, Super-P, CMC, SBR and distilled water in a weight ratio of 60:25:5:6:4:60. Briefly, 6 parts of CMC by weight was first mixed with 60 parts of distilled water by weight and homogenized at a speed of 550 rpm for about 1 hr. The mixture was subjected to ultra-sonication for 10 min, then added 25 parts of Super-P by weight. The resultant solution was continuously stirred at a speed of 600 rpm for 20 min, then added 25 parts of KS6 by weight. Continued to stir the resultant solution at the speed of 600 rpm for another 20 min, then added 60 parts of the zinc vanadate composite of example 1.1.1 by weight with continued agitation at the same speed for 20 min. Four parts of SBR by weight was added to the resultant solution and the entire mixture was sonicated for 5 min, followed by continued agitation for about 12-15 hrs, or until all powders were homogeneously dispersed therein. Viscosity of the resultant solution was checked intermittently.

The slurry composition of example 1.1.1.2 was used to coat a copper foil, which was then subject to dryness, compressed, and subsequently cut into suitable size for subsequent use in assembling a sodium battery.

1.1.2 Anode Material Comprising Cobalt Vanadate Composite

1.1.2.1 Cobalt Vanadate Composite

Ammonium metavanadate (NH₄VO₃, 6 mmol) and cobalt nitrate hexahydrate (Co(NO₃)₂.6H₂O, 3 mmol) were mixed in ethanol (60 mL) with continued agitation at a speed of 400 rpm for about 30 min, then added hydrazine (3 mmol). Continued to stir the solution at 400 rpm for a few mins, then the mixture was transferred to a Teflon-lined autoclaved vessel (100 mL in volume) that was maintained at 200° C. for 48 hrs, before cooling down to ambient temperature. Black precipitates were collected and washed with ethanol, then were subjected to vacuum dried in an oven at 80° C. for overnight. The dried powders were then sintered at 500° C. for 8 hrs at a reducing atmosphere of 15% H₂/85% N₂, and stored in a desiccated place until use.

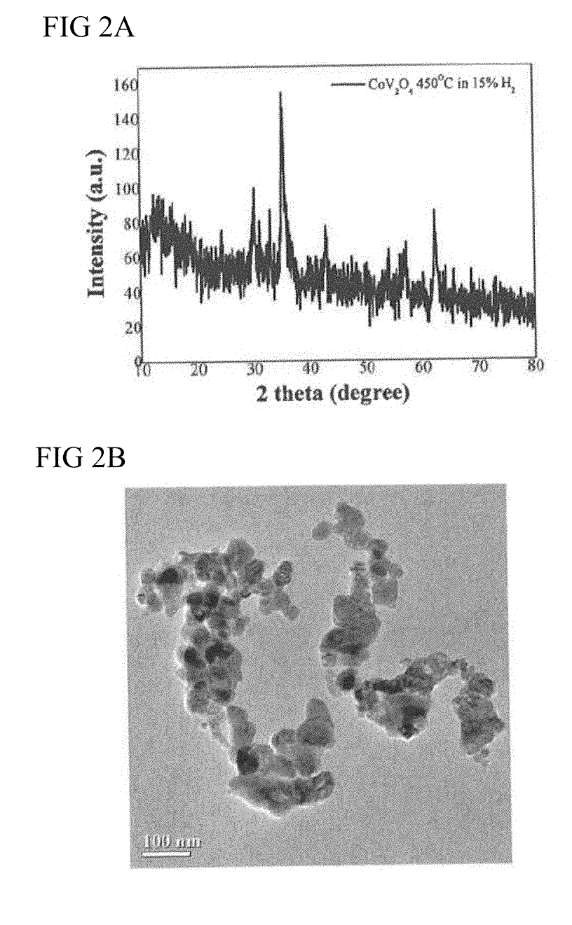

FIGS. 2A and 2B respectively illustrate the X-ray crystallography and scanning electromagnetic microscopy photograph of the thus produced cobalt vanadate composite. The cobalt vanadate composite of the present example is about 50 nm in diameter.

1.1.2.2 Slurry Composition Comprising the Cobalt Vanadate Composite of Example 1.1.2.1

In general, the slurry composition comprising the cobalt vanadate composite of example 1.1.2.1 was prepared in accordance with procedures as described in example 1.1.1.2 except the zinc vanadate composite of example 1.1.1.1 was replace by the cobalt vanadate composite of example 1.1.2.1.

The slurry composition of example 1.1.2.2 was used to coat a copper foil, which was then subject to dryness, compressed, and subsequently cut into suitable size for subsequent use in assembling a sodium battery.

1.1.3 Anode Material Comprising Iron Vanadate Composite

1.1.3.1 Iron Vanadate Composite

Ammonium metavanadate (NH₄VO₃, 6 mmol) and ferric nitrate nonahydrate (Fe(NO₃)₃.9H₂O, 3 mmol) were mixed in distilled water (60 mL) with continued agitation at a speed of 400 rpm for about 30 min, then added 2-hydroxy-butane-1,4-dioic acid (1.8 mmol). Continued to stir the solution at 400 rpm for a few mins, then adjusted the pH of the solution to 7.0 by adding suitable amount of ammonium hydroxide. The mixture was then transferred to a Teflon-lined autoclaved vessel (100 mL in volume) that was maintained at 200° C. for 48 hrs, before cooling down to ambient temperature. Black precipitates were collected and washed with ethanol, then were subjected to vacuum dried in an oven at 80° C. for overnight. The dried powders were then sintered at 500° C. for 8 hrs at a reducing atmosphere of 15% H₂/85% N₂, and stored in a desiccated place until use.

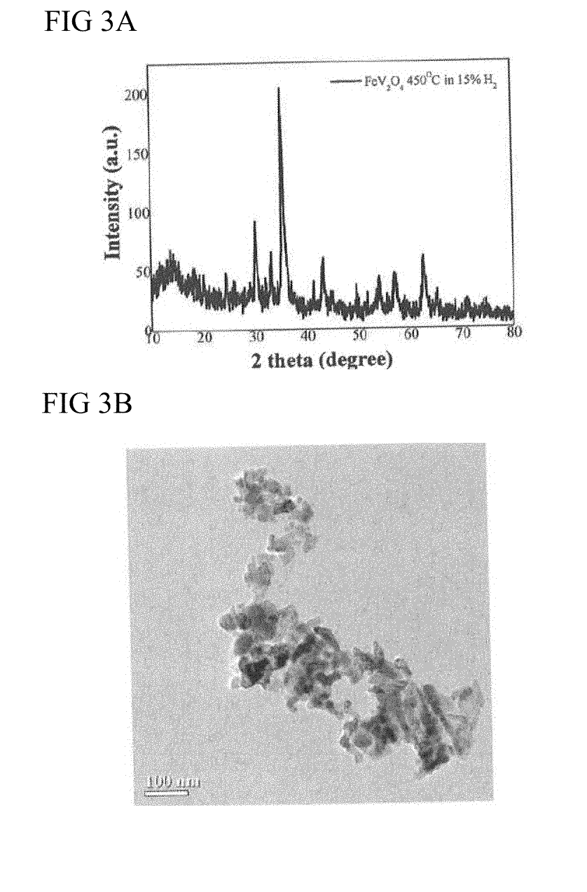

FIGS. 3A and 3B respectively illustrate the X-ray crystallography and scanning electromagnetic microscopy photograph of the thus produced iron vanadate composite. The iron vanadate composite of the present example is about 20 nm in diameter.

1.1.3.2 Slurry Composition Comprising the Iron Vanadate Composite of Example 1.1.3.1

In general, the slurry composition comprising the iron vanadate composite of example 1.1.3.1 was prepared in accordance with procedures as described in example 1.1.1.2 except the zinc vanadate composite of example 1.1.1.1 was replace by the iron vanadate composite of example 1.1.3.1.

The slurry composition of example 1.1.3.2 was used to coat a copper foil, which was then subject to dryness, compressed, and subsequently cut into suitable size for subsequent use in assembling a sodium battery.

1.2 Sodium Cell Assembly

The sodium cell was assembled under argon environment using the coated anode material as prepared in examples 1.1.1, 1.1.2. or 1.1.3; a commercially available cathode material (i.e., sodium disk) and a polypropylene film separator sandwiched between the electrodes. The separator was soaked with an electrolytic solution comprising ethylene carbonate (EC), propylene carbonate (PC), diethyl carbonate (DEC), and lithium hexafluorophosphate (LiPF₆), with the addition of bismaleimide and vinylene carbonate as the additive of the electrolytic solution.

### Example 2 Electrochemical Evaluation of the Sodium Cells of Example 1.2

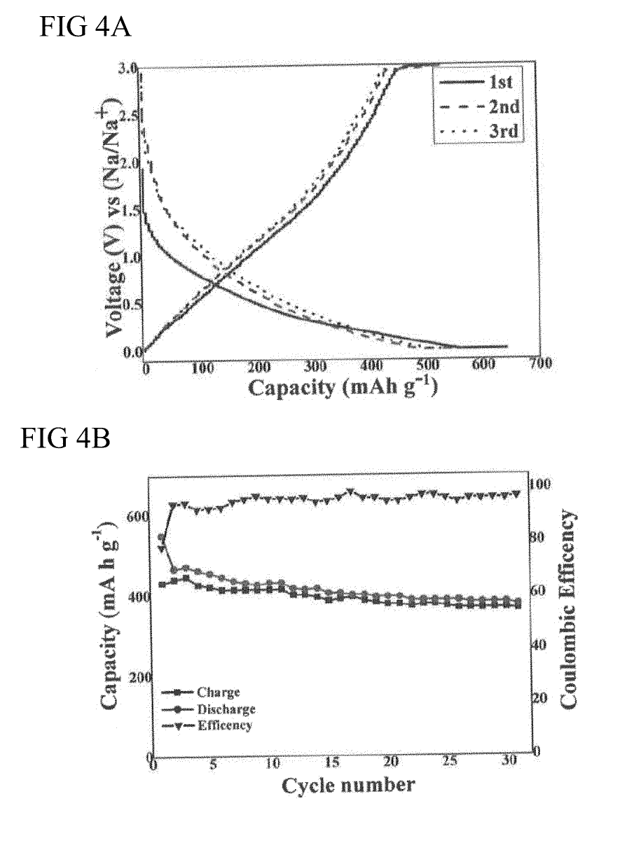

The sodium cells of example 1.2 were subject to charge and discharge test at constant current/voltage. Specifically, the cells were first charged to 3.0 V with a constant current of 0.14 mA/cm² until the current is less than or equal to 0.014 mA; then discharged to a cut-off voltage of 0.01 with a constant current of 0.14 mA/cm², and the process was repeated for 3 times. The charge and discharge profiles of the sodium cells of example 1.2 are respectively illustrated in FIGS. 4 to 6.

FIG. 4A is a line graph depicting the capacity per gram (milliamp hours per gram, mAh/g) and the efficiency of the sodium cell constructed by use of the coated anode material of examples 1.1.1, while FIG. 4B illustrates the number of charge and discharge cycles and the battery capacity. It is evident that the battery efficiency of the sodium cell comprising the anode material of zinc vanadate composite remained at a stable level even after 30 cycles of charge and discharge.

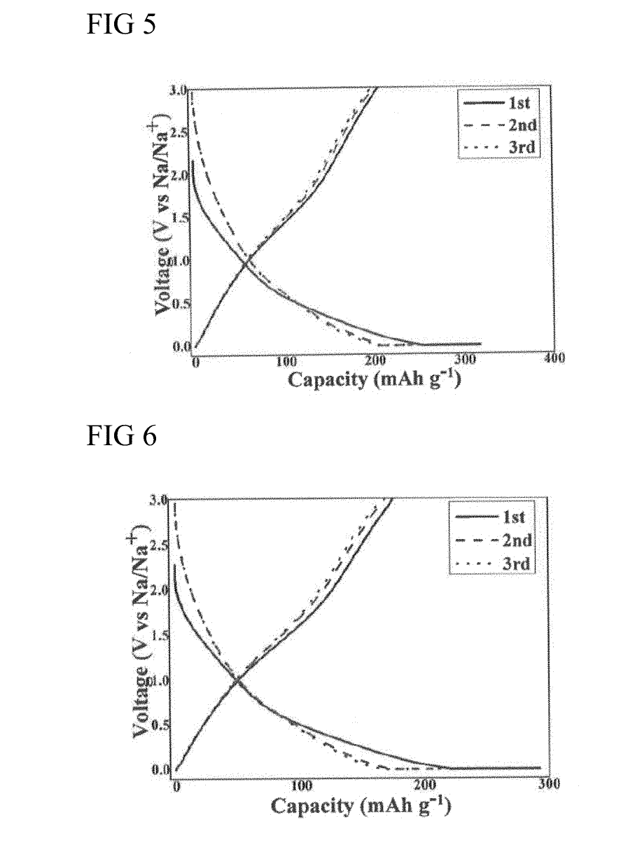

Similar results were also found for sodium cell comprising anode material of cobalt vanadate composite (FIG. 5), and sodium cell comprising anode material of iron vanadate composite (FIG. 6).

Taken together, it is clear that a coated anode material comprising metal oxide composite of the present invention may improve the electrode chemical performance of the thus produced cell, including good charging and discharging performance, enhanced electric capacity and cycle life.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1-9. (canceled)

10. A battery comprising,
an anode, which is composed of a copper or an aluminum foil coated with a slurry composition comprising an anode material comprising a metal oxide composite having a spinel structure and a formula of AB₂O₄, wherein, A is selected from the group consisting of: zinc, cobalt, iron, nickel, magnesium, manganese, copper and cadmium; and B is selected from the group consisting of: vanadium, cobalt, iron, boron, aluminum, gallium, chromium, and manganese;
a cathode; and
an electrolyte solution;
wherein, the anode, the cathode and the electrolyte solution are configured to form a sodium secondary battery.

11. The sodium secondary battery of claim 10, wherein in the metal oxide composite having the formula of AB₂O₄, A is zinc and B is vanadium.

12. The sodium secondary battery of claim 10, wherein in the metal oxide composite having the formula of AB₂O₄, A is cobalt and B is vanadium.

13. The sodium secondary battery of claim 10, wherein in the metal oxide composite having the formula of AB₂O₄, A is iron and B is vanadium.

14. The sodium secondary battery of claim 10, wherein the metal oxide composite is produced by a process selected from the group consisting of: hydrothermal, sol-gel, solid state reaction, high energy ball milling, co-sedimentation and a combination thereof.

15. The sodium secondary battery of claim 14, wherein the metal oxide composite is produced by the hydrothermal process, in which the hydrotheinial reaction is conducted at a reaction temperature between 25-300° C. for about 1 hour to 7 days.

16. The sodium secondary battery of claim 15, wherein the hydrothermal reaction is conducted at the reaction temperature of 200° C. for about 3 days.

17. The sodium secondary battery of claim 15, wherein the hydrothermal process further comprises sintering the metal oxide composite at a temperature between 200-1,200° C. for about 10 minutes to 72 hours.

18. The sodium secondary battery of claim 17, wherein the metal oxide composite is sintered at the temperature between 400-600° C. for about 8 hours.
